(19) United States
(12) Patent Application Publication
(10) Pub. No.: US 2023/0408193 A1
(43) Pub. Date: Dec. 21, 2023

(54) APPARATUS AND METHOD FOR SEPARATING AIR

(71) Applicant: L'Air Liquide, Societe Anonyme pour l'Etude et l’Exploitation des Procedes Georges Claude, Paris (FR)

(72) Inventors: John PACHON MORALES, Champigny-Sur-Marne (FR); Mikael WATTIAU, Jouy-en-Josas (FR); Bernard LABEGORRE, Jouy-ens-Josa (FR); Lian-Ming SUN, Hangzhou (CN)

(73) Assignee: L'Air Liquide, Societe Anonyme pour l'Etude et l’Exploitation des Procedes Georges Claude, Paris (FR)

(21) Appl. No.: 18/200,680

(22) Filed: May 23, 2023

(30) Foreign Application Priority Data
May 23, 2022 (FR) FR 2204917
Jul. 11, 2022 (FR) FR 2207089

(51) Int. Cl. F25J 3/04

(52) U.S. Cl. CPC F25J 3/04927; F25J 2240/22; F25J 2240/12; F25J 3/04387

(57) ABSTRACT

Apparatus for separating air comprising a device for breaking up a jet of cryogenic liquid in a gas flow, comprising a supply pipeline for the cryogenic liquid having an inside diameter greater than or equal to 10 mm, and a gas pipe of circular section, with a diameter d, the gas pipe comprising a portion having a reduction in diameter by a ratio of 20 to 50% at the point of injection of liquid and over a distance y wherein:

y=n×d

and wherein the supply pipeline penetrates the gas pipe such that its end is in the portion of the pipe having the reduction in diameter and n is between 7 and 9.

### CROSS REFERENCE TO RELATED APPLICATIONS

This application claims the benefit of priority under 35 U.S.C. § 119 (a) and (b) to French patent application No. FR2204917, filed May 23, 2022, and French Patent application No. FR2207089, filed Jul. 11, 2022, both of which are herein incorporated by reference in their entireties.

### FIELD OF THE INVENTION

The present invention relates to an apparatus and to a method for separating air. The apparatus comprises a device for breaking up a cryogenic liquid in a gas pipe.

### BACKGROUND OF THE INVENTION

It is sometimes necessary to inject a cryogenic liquid into a pipe in which a gas is circulating.

In a conventional design of an apparatus for separating air without a liquid oxygen pump, a purge of liquid makes it possible to deconcentrate the bath of liquid oxygen into hydrocarbon. The resulting cold can be used in the main exchanger, being injected into the residual nitrogen after a first pass. The surplus pressure which makes it possible to inject the liquid primarily comes from the hydrostatic height due to the weight of the purge liquid. There is thus a low flow rate of cryogenic liquid which will be vaporized in a flow rate of gas which is greater and superheated.

In some cases, the residual nitrogen can then pass into a turbine through expansion. However, the wheel of a turbine is sensitive to potential impacts from drops. It is therefore necessary to ensure that the liquid is completely vaporized before reaching the turbine.

It is also possible to inject the cryogenic liquid into a gas containing between 45 and 95 mol % of oxygen, for example between 72 and 82 mol % of oxygen.

### SUMMARY OF THE INVENTION

In certain embodiments, the present invention relates to a device for injecting cryogenic liquid into a gas pipe. The gas is preferably at a temperature below 0° C., having been partially heated in the main heat exchanger of the apparatus for separating air, being a product of a method for the cryogenic distillation of air.

The easiest way to do this is simply to connect the two pipes in such a way that they emerge into a single pipe. The injection is therefore a wall injection. This could be considered to be sufficient in so far as there may be a difference in temperature of several dozen degrees between the two fluids and the flow rate of gas is strictly greater than the flow rate of liquid.

However, in reality, the exchange coefficients are low at the cryogenic temperatures in question. To be specific, the speed of the liquid is too low for the jet to penetrate far from the wall. Moreover, the drops generated in this configuration are, according to the models available in the literature in the field of combustion, on a millimetric scale such that they are slow to evaporate. The risk of the liquid line becoming blocked in fact makes it necessary to use a relatively high pipe diameter, and therefore both a low speed for the liquid and above all a typically large size.

Moreover, the drops are quickly accelerated up to the speed of the gas, relative speed thus being lost, with transfer primarily by diffusion, which is less effective than transfer by convection.

One natural manner for a person skilled in the art to improve mixing is to add a static mixer in the pipe downstream of the injection. However, once the liquid is in droplets, such a device is either not very effective, as the droplets follow the currents of the gas, or even counter-productive, since if the drops are deposited on the mixer, then the liquid is further broken up at the outlet of the mixer, the size of the drops being difficult to predict.

Another manner, which is conventional in chemical engineering, is to distribute the liquid on a packed bed which in this case is in the pipe, or to use a nozzle with a high pressure loss to spray the liquid in fine droplets. These two techniques, which are relatively complex, are rendered impossible by the requirement to keep a large cross section for passage of the liquid so as to limit the risk of blockage.

Aim of the Invention

The aim of certain embodiments of the invention is to propose a configuration that is simple to produce and to install in order to promote evaporation of the cryogenic liquid, while limiting the risk of blockage in the liquid pipeline.

Disclosure and Advantages of the Invention

To this end, certain embodiments of the present invention relate to an apparatus for separating air by cryogenic distillation, comprising a heat exchanger for cooling air by exchange of heat with a gas, a system of columns comprising at least one distillation column for separating air cooled in the exchanger, a pipeline for supplying cryogenic liquid having an end, and a gas pipe, characterized in that the liquid supply pipeline has an inside diameter greater than or equal to 10 mm, preferably greater than or equal to 20 mm, and the gas pipe (T) has a circular section, and a diameter d of less than 600 mm, preferably less than 450 mm, over more than 50% of its length, the gas pipe comprising a portion having a reduction in diameter by a ratio of 20 to 50% at the point of injection of liquid and over a distance y wherein:

y=n×d

and wherein the supply pipeline penetrates the gas pipe such that its end is in the portion of the pipe having the reduction in diameter and n is between 7 and 9, preferably between 7.5 and 8.5, in order to break up a jet of cryogenic liquid in the gas flow, the gas pipe (T) being connected to the exchanger so as to be supplied with gas produced by a column of the system of columns and the liquid pipeline being connected to the system of columns so as to be supplied with a liquid produced by a column of the system of columns.

According to other, optional aspects of the apparatus:
the difference in pressure between the fluids is due to the hydrostatic pressure of the liquid in its pipe;
the cryogenic liquid supply pipeline has an inside diameter greater than or equal to 10 mm, preferably greater than or equal to 20 mm so as to limit the risk of blockage;
the superheating of the gas is between 10 and 30° C. above the dew point;
the cryogenic liquid supply pipeline penetrates as far as the middle of the gas pipe;
the gas pipe has a reduction in diameter by a ratio of 20 to 50% at the point of injection of liquid over a distance corresponding to 1 to 5 times the distance for breaking up the jet.

According to other optional subjects of the invention, in the apparatus:
a liquid injection nozzle is arranged at the end of the pipeline (this makes it possible to generate atomization in film form and the nozzle is resistant to blockage);
the nozzle is of the flat jet type capable of producing a flat jet or a jet in sheet form;
the end of the pipeline is within a radius of d/10 around the central axis of the gas pipe;
the supply pipeline penetrates the gas pipe such that its end is at the start of the portion of the pipe having the reduction in diameter;
the gas pipe has a first section having a first diameter and a second section having a second diameter which is less than the first diameter by a ratio of 20 to 50%;
the gas pipe has an intermediate section between the first section and the second section;
the end of the supply pipeline is in the intermediate section or the second section;
the system of columns comprises a column having a bottom surrounded by a liquid which is rich in oxygen compared to air, the pipeline being connected to this bottom;
the system of columns comprises a column having a top-end condenser containing a liquid which is rich in oxygen compared to air, the pipeline being connected to the condenser;
the apparatus comprising a turbine, the gas pipe being connected to the system of columns so as to send to the portion of the pipe having a reduction in diameter a gas which is rich in nitrogen compared to air and the portion of the pipe having a reduction in diameter being connected to the turbine so as to send to it the gas rich in nitrogen in which the liquid has been broken up;
the liquid pipeline is arranged such that the liquid is pressurized by hydrostatic pressure.

According to another subject of the invention, it provides a method for separating air by cryogenic distillation wherein air is cooled in a heat exchanger by exchange of heat with a gas, air cooled in the exchanger is separated in a system of columns comprising at least one distillation column, characterized in that a jet of cryogenic liquid is broken up in a gas flow, wherein a cryogenic liquid at a temperature below −100° C. circulates in a supply pipeline having an end, the liquid supply pipeline has an inside diameter greater than or equal to 10 mm, preferably greater than or equal to 20 mm, and a gas at a temperature of between 10 and 30° C. above its dew point circulates in a gas pipe of circular section, having a diameter d over more than 50% of its length, the gas pipe comprising a portion having a reduction in diameter by a ratio of 20 to 50% at the point of injection of liquid over a distance y wherein:

y=n×d

wherein the liquid is sent via the supply pipeline which penetrates the gas pipe such that its end is in the portion of the pipe having the reduction in diameter and the liquid emerges in this portion of the pipe, and n is a number between 7 and 9, preferably between 7.5 and 8.5, the gas pipe being connected to the exchanger and being supplied with gas produced by a column of the system of columns and the liquid pipeline being connected to the system of columns and being supplied with a liquid produced by a column of the system of columns. Preferably, the gas and the liquid circulate from top to bottom. Thus, the hydrostatic pressure contributes to the pressurization of the mixture.

A purely hydrostatic pressure makes it possible to avoid the use of a complex and fragile pump.

The gas in which the liquid is broken up may be residual nitrogen or may contain between 45 and 95 mol % of oxygen.

### BRIEF DESCRIPTION OF THE DRAWINGS

Other features and advantages of the invention will be further disclosed in the description that follows, and in several embodiments provided as non-limiting examples in reference to the appended schematic drawings, in which:

FIG. 1 shows the sizes of drops calculated by various models as a function of the load of the apparatus.

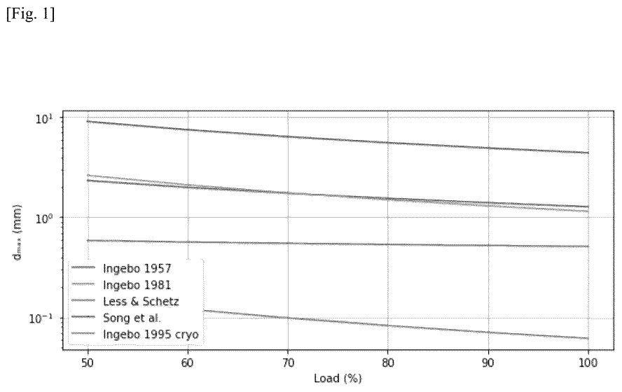

FIG. 2 shows the evaporation time and the distance travelled before evaporation of a drop as a function of its initial size.

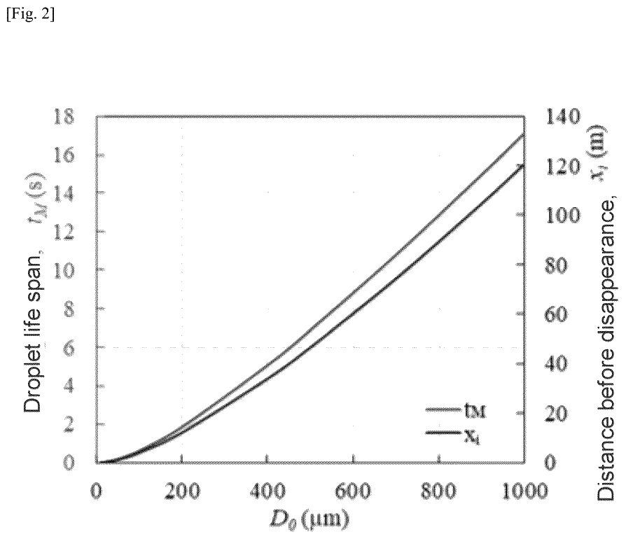

FIG. 3 shows models of maximum drop size as a function of the diameter of the gas pipe in a configuration with a liquid jet in a transverse gas flow. The reduction in diameter of the gas pipelines at the point of injection and over the distance for breaking up the liquid jet makes it possible to reduce the maximum size of the drops.

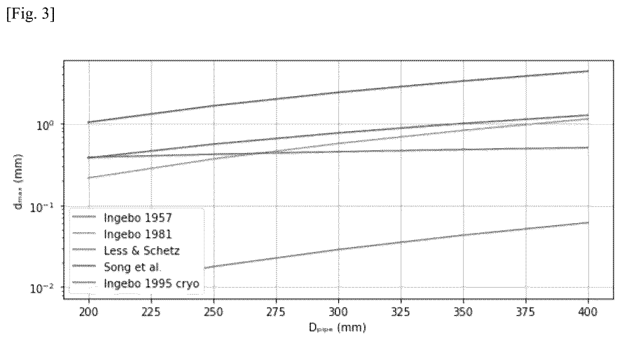

FIG. 4 shows a device for breaking up liquid in a gas pipe to be incorporated in an apparatus for separating air, with a configuration with central injection (left-hand side) and a configuration with central injection and reduction in diameter of the gas pipe according to the invention (right-hand side).

FIG. 5 shows an apparatus for separating air by cryogenic distillation according to the invention.

### DETAILED DESCRIPTION OF THE INVENTION

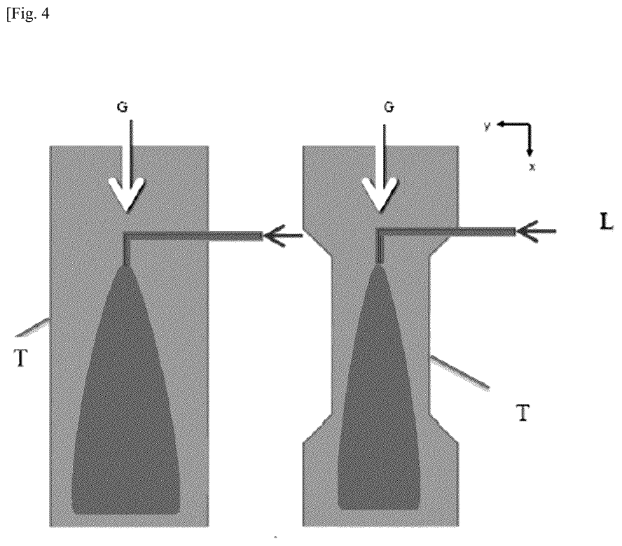

FIG. 4 shows the configuration with central injection (left-hand side) and with central injection and reduction in diameter of the gas pipe according to the invention (right-hand side). The right-hand figure shows liquid L being sent to the centre of the gas G pipe T. The right-hand figure shows the right-hand pipe T having a diameter d of less than 600 mm, preferably less than 450 mm over most of its length, in other words more than 50% of its length, and a portion of its length having a reduction in diameter by a ratio of 20 to 50% at the point of injection of liquid at a temperature below −100° C. over a distance y wherein:

y=n×d

wherein n is between 7 and 9, preferably between 7.5 and 8.5, for example 8.

The gas G is preferably at a temperature between 10 and 30° C. above its dew point. The end of the liquid injection pipeline is within a radius of d/10 around the central axis of the gas pipe T; this reduction in diameter of the gas pipe over the distance y for breaking up the liquid jet makes it possible to reduce the maximum initial size of the drops.

The gas pipe T in the right-hand figure has a first section having a first diameter and a second section having a second diameter which is less than the first diameter by a ratio of 20 to 50%. The gas pipe T has an intermediate section between the first section and the second section. The end of the liquid L supply pipeline is in the intermediate section or the second section, since the reduction in diameter in the narrowest portion of the intermediate section is still between 20 and 50% of the diameter.

The supply of cryogenic liquid to the centre of the gas pipeline makes it possible to promote mixing between the gas and the liquid while limiting the risk of coalescence on the wall.

The use of a flat jet nozzle provides a first mechanism for atomization in film form, which limits the initial drop size while retaining a diameter for passage which is sufficient to prevent blockage. A flat jet nozzle is known from FR3113608 and FR3107659.

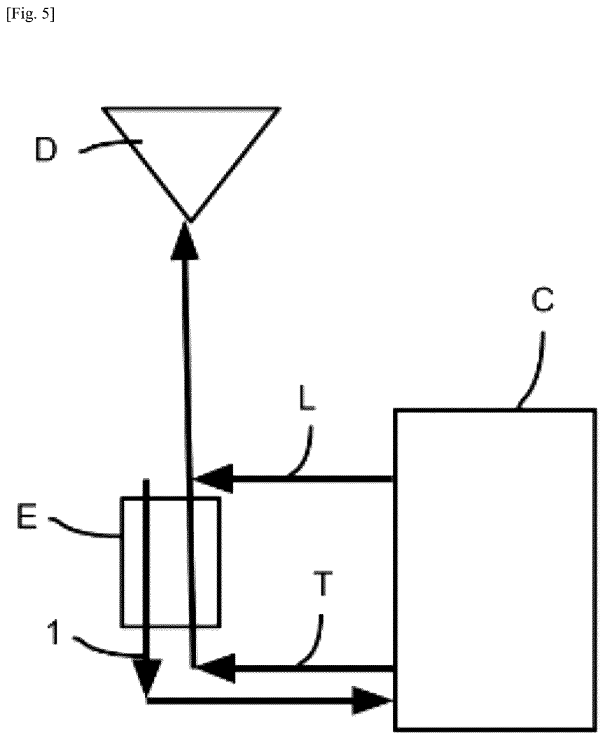

The device is incorporated in an apparatus for separating air by distillation shown in FIG. 5. An apparatus for separating air by cryogenic distillation A comprises a heat exchanger E for cooling air 1 by exchange of heat with the gas 1, and a system of columns C comprising at least one distillation column for separating air cooled in the exchanger.

The system of columns may comprise a single column or a first column operating at a first pressure and a second column operating at a second pressure, the top of the first column being thermally coupled to the bottom of the second column. The gas pipe T is connected to the exchanger E so as to be supplied with gas produced by a column of the system of columns C. The gas may be heated in the heat exchanger E before being sent to the device such that the gas arrives at the device at a temperature between 10 and 30° C. above its dew point. The liquid pipeline is connected to the system of columns so as to be supplied with a liquid produced by a column of the system of columns at a temperature below −100° C. The liquid preferably corresponds to a purge of the system of columns.

According to one variant, the system of columns comprises a column, for example the second column, having a bottom surrounded by a liquid which is rich in oxygen compared to air, the pipeline being connected to this bottom.

According to another variant, the system of columns comprises a column, for example a single column, having a top-end condenser containing a liquid which is rich in oxygen compared to air, the pipeline being connected to the condenser.

The apparatus may comprise a turbine D, the gas pipe T being connected to the system of columns so as to send to the device a gas which is rich in nitrogen compared to air and the device being connected to the turbine so as to send to it the gas rich in nitrogen in which the liquid has been broken up.

The liquid pipeline is arranged such that the liquid is pressurized by hydrostatic pressure. In this case, it is sometimes possible to dispense with a pump for sending the liquid to the device.

The gas in which the liquid is broken up may be residual nitrogen or may contain between 45 and 95 mol % of oxygen.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. An apparatus for separating air by cryogenic distillation, the apparatus comprising:
a heat exchanger configured to cool air by exchange of heat with a gas,
a system of columns comprising at least one distillation column configured to separate air cooled in the exchanger,
a pipeline configured to supply cryogenic liquid having an end, and
a gas pipe,
wherein the liquid supply pipeline has an inside diameter greater than or equal to 10 mm, and the gas pipe has a circular section, and a diameter d of less than 600 mm over more than 50% of its length, the gas pipe comprising a portion having a reduction in diameter by a ratio of 20 to 50% at the point of injection of liquid and over a distance y wherein:
y=n×d
and wherein the supply pipeline penetrates the gas pipe such that its end is in the portion of the gas pipe having the reduction in diameter and n is between 7 and 9 in order to break up a jet of cryogenic liquid in the gas flow,
wherein the gas pipe is connected to the exchanger so as to be supplied with gas produced by the system of columns and the liquid pipeline being connected to the system of columns so as to be supplied with a liquid produced by the system of columns.

2. The apparatus according to claim 1, wherein a liquid injection nozzle is arranged at the end of the pipeline.

3. The apparatus according to claim 2, wherein the nozzle is of the flat jet type capable of producing a flat jet or a jet in sheet form.

4. The apparatus according to claim 1, wherein the end of the pipeline is within a radius of d/10 around the central axis of the gas pipe.

5. The apparatus according to claim 1, wherein the system of columns comprises a column having a bottom surrounded by a liquid which is rich in oxygen compared to air, the pipeline being connected to this bottom.

6. The apparatus according to claim 5, wherein the system of columns comprises a column having a top-end condenser containing a liquid which is rich in oxygen compared to air, the pipeline being connected to the condenser.

7. The apparatus according to claim 1, comprising a turbine, the gas pipe being connected to the system of columns so as to send to the portion of the pipe having a reduction in diameter a gas which is rich in nitrogen compared to air and the portion of the pipe having a reduction in diameter being connected to the turbine so as to send to it the gas rich in nitrogen in which the liquid has been broken up.

8. The apparatus according to claim 1, wherein the liquid pipeline is arranged such that the liquid is pressurized by hydrostatic pressure.

9. A method for separating air by cryogenic distillation, the method comprising the steps of:
cooling air in a heat exchanger by exchange of heat with a gas,
separating the air cooled in the exchanger in a system of columns comprising at least one distillation column,
breaking up a jet of cryogenic liquid in a gas flow,
circulating a cryogenic liquid at a temperature below −100° C. in a supply pipeline having an end, wherein the liquid supply pipeline has an inside diameter greater than or equal to 10 mm, and
circulating a gas at a temperature of between 10 and 30° C. above its dew point in a gas pipe of circular section, having a diameter d over more than 50% of its length, the gas pipe comprising a portion having a reduction in diameter by a ratio of 20 to 50% at the point of injection of liquid over a distance y wherein:
y=n×d
transferring the liquid via the supply pipeline, which penetrates the gas pipe such that its end is in the portion of the gas pipe having the reduction in diameter, such that the liquid emerges in said portion of the gas pipe, and n is a number between 7 and 9, the gas pipe being connected to the exchanger and being supplied with gas produced by the system of columns and the liquid pipeline being connected to the system of columns and being supplied with a liquid produced by the system of columns.

10. The method according to claim 9, wherein the cryogenic liquid and the gas circulate from top to bottom.

11. The method according to claim 9, wherein the gas is residual nitrogen.

12. The method according to claim 9, wherein the gas contains between 45 and 95 mol % of oxygen.
